(19) United States
(12) Patent Application Publication
(10) Pub. No.: US 2026/0213973 A1
(43) Pub. Date: Jul. 23, 2026

(54) IN-VEHICLE COMMUNICATION SYSTEM AND CONTROL METHOD OF IN-VEHICLE COMMUNICATION SYSTEM

(71) Applicant: DENSO CORPORATION, Kariya-city (JP)

(72) Inventors: Sho MATSUMOTO, Kariya-city (JP); Tomohisa KISHIGAMI, Kariya-city (JP)

(21) Appl. No.: 19/450,466

(22) Filed: Jan. 15, 2026

(30) Foreign Application Priority Data
Jan. 21, 2025 (JP) 2025-008740

(51) Int. Cl. H04L 12/40

(52) U.S. Cl. CPC H04L 12/40006; H04L 12/40189; H04L 2012/40273

(57) ABSTRACT

An in-vehicle communication system is provided in which at least two or more communication paths are present each for a communication frame including a control message transmitted from an upper-level control device to reach a lower-level control device via a middle-level control device. The upper-level control device repeatedly transmits the communication frame including the control message to the at least two or more communication paths such that each communication frame includes identification information used to identify an ordinal of the communication frame in a transmitting order. The lower-level control device determines whether or not to execute a control process based on the control message included in the received communication frame, based on determining whether or not the ordinal of the received communication frame in the transmitting order is the same as or older than that of the previously received communication frame.

### CROSS-REFERENCE OF RELATED APPLICATIONS

This application is based on Japanese Patent Application No. 2025-008740 filed in Japan on January 21, 2025. The entire disclosure of the above application is incorporated herein by reference.

### TECHNICAL FIELD

The present disclosure relates to an in-vehicle communication system including a plurality of control devices, and a control method of the in-vehicle communication system.

### BACKGROUND

There is a technology of an in-vehicle communication system in which a gateway device relays a communication frame.

In such an in-vehicle communication system, the communication frames may not always reach a destination in the same order as the communication frames are transmitted, due to some factors. This may cause disadvantages.

### SUMMARY

According to a first aspect of the present disclosure, an in-vehicle communication system is provided in which there are at least two or more communication paths each for a communication frame including a control message transmitted from an upper-level control device to reach a lower-level control device via a middle-level control device. The upper-level control device repeatedly transmits the communication frame including the control message to the at least two or more communication paths such that each communication frame includes identification information used to identify an ordinal of the communication frame in a transmitting order. The lower-level control device determines whether or not to execute a control process based on the control message included in the received communication frame, based on determining whether or not the ordinal of the received communication frame in the transmitting order is the same as or older than that of the previously received communication frame.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating an example of a configuration of an in-vehicle communication system according to a first embodiment;

FIG. 2 is a diagram illustrating a first communication path and a second communication path as communication paths through which an upper-level ECU transmits a communication frame including a control message to a first lower-level ECU;

FIG. 3 is a diagram for describing an issue that can arise when the upper-level ECU transmits the communication frame including the control message to the first lower-level ECU via the first communication path and the second communication path;

FIG. 4 is a flowchart illustrating processes related to transmission by the upper-level ECU of the communication frame according to the first embodiment;

FIG. 5 is a flowchart illustrating processes related to receipt by the first, second lower-level ECU of the communication frame according to the first embodiment;

FIG. 6 is a sequence diagram for describing operations and effects of the processes related to the transmission by the upper-level ECU of the communication frame and the processes related to receipt by the first, second lower-level ECU of the communication frame according to the first embodiment;

FIG. 7 is a flowchart illustrating processes related to receipt by the first, second lower-level ECU of the communication frame according to a second embodiment;

FIG. 8 is a sequence diagram for describing operations and effects of the processes related to the transmission by the upper-level ECU of the communication frame according to the second embodiment;

FIG. 9 is a flowchart illustrating processes executed by the upper-level ECU for abnormality detection according to a third embodiment;

FIG. 10 is a diagram for describing the abnormality detection function of the upper-level ECU according to the third embodiment;

FIG. 11 is a flowchart illustrating processes executed by the first, second middle-level ECU for abnormality detection according to the third embodiment;

FIG. 12 is a diagram for describing the abnormality detection function of the first, second middle-level ECU according to the third embodiment;

FIG. 13 a diagram illustrating a configuration of an in-vehicle communication system according to a first modification; and

FIG. 14 a diagram illustrating a configuration of an in-vehicle communication system according to a second modification.

### DETAILED DESCRIPTION

There is a technology of an in-vehicle communication system. For example, in the in-vehicle communication system, gateway devices which perform a relay process are connected to each other via multiple communication lines. In message transmission from one gateway device to another, each gateway device outputs the same message to the multiple communication lines. A timestamp is embedded in each message. The gateway device, which receives the message via the multiple communication lines, determines whether or not the message is the same as the previously received message, based on the time stamp. Upon determining that the message is the same, the gateway device discards the received message. Upon determining that the message is the first-received message, the gateway device executes a necessary process such as a relay process.

In an in-vehicle communication system, for example, control devices (communication nodes) which perform communications may be arranged in a hierarchical manner, such as an upper-level control device, a middle-level control device and a lower-level control device. In this in-vehicle communication system, an upper-level control device may transmit a control message to a lower-level control device by means of a communication frame to indicate a control content to be executed, in order to supervise the control in the lower-level control device. In this case, the communication frame including the control message is repeatedly transmitted over time for a purpose of optimizing a control state according to vehicle state or the like. The middle-level control device relays (gateways) the communication frame repeatedly transmitted from the upper-level control device, toward a subordinate which is the lower-level control device. The lower-level control device executes a control process according to the control message in the received communication frame.

When the in-vehicle communication system described above is applied to a system for controlling an important function of a vehicle such as a drive system, a steering system, a braking system of the vehicle, consideration should be given to ensure that the communication frame including the control message reaches the lower-level control device. Therefore, for example, via multiple communication paths, the upper-level control device may transmit the communication frame including the same control message to the lower-level control device. In this case, even if an abnormality of communication failure occurs in one of the communication paths, the lower-level control device can receive the communication frame including the control message via the communication path that is normal.

However, the communication frames may not always reach the lower-level control device in the same order as the communication frames are transmitted, due to such factors as path lengths of multiple communication paths, a difference in hardware and/or software performance between the middle-level control devices, communication load states of multiple communication paths, a speed difference between communication protocols used for communications in multiple communication paths, etc. For example, it is conceivable that an older communication frame, which is transmitted earlier, may reach the lower-level control device later than a newer communication frame, which is transmitted later. In this case, the lower-level control device executing a control process according to an olde control message in the older communication frame may have a difficulty in performing optimal control according to vehicle state or the like.

The in-vehicle communication system in the above technology determines only whether or noy the message is the same. Therefore, the above-mentioned issue cannot be solved by the technology described in the above technology.

It is therefore an object of the present disclosure to provide an in-vehicle communication system and a control method of the in-vehicle communication system that, in cases where control devices are hierarchically arranged and a upper-level control device transmits a communication frame including a control message to a lower-level control device via a middle-level control device, can prevent inappropriate control execution according to a control message in an older communication frame while increasing a possibility that the communication frame reaches the lower-level control device.

According to a first aspect of the present disclosure, an in-vehicle communication system comprising a plurality of control devices is provided, wherein:

the plurality of control devices includes a upper-level control device that transmits a communication frame including a control message, a middle-level control device that relays the communication frame transmitted by the upper-level control device, and a lower-level device that received the communication frame relayed by the middle-level control device and performs a control process based on the control message included in the received communication frame,

one or more communication lines are connected between the upper-level control device, the middle-level control device and the lower-level control device so that at least two or more communication paths are present each for the communication frame including the control message transmitted from the upper-level control device to reach the lower-level control device,

the upper-level control device repeatedly transmits the communication frame including the control message to the at least two or more communication paths over time, wherein each communication frame includes identification information used to identify an ordinal of the communication frame in a transmitting order,

the lower-level control device determines whether or not the ordinal of the received communication frame in the transmitting order is the same as or older than that of the previously received communication frame, based on the identification information of the received communication frame, and

the lower-level control device is configured such that:

upon determining that the ordinal of the received communication frame in the transmitting order is not the same as nor older than that of the previously received communication frame but is newer than that of the previously received communication frame, the lower-level control device executes the control process based on the control message included in the received communication frame; and

upon determining that the ordinal of the received communication frame in the transmitting order is the same as or older than that of the previously received communication frame, the lower-level control device does not execute the control process based on the control message included in the received communication frame.

According to a second aspect of the present disclosure, a control method of an in-vehicle communication system including a plurality of control devices is provided, wherein:

the plurality of control devices includes a upper-level control device that transmits a communication frame including a control message, a middle-level control device that relays the communication frame transmitted by the upper-level control device, and a lower-level control device that receives the communication frame relayed by the middle-level control device and performs a control process based on the control message included in the received communication frame, and

one or more communication lines are connected between the upper-level control device, the middle-level control device and the lower-level control device so that at least two or more communication paths are present for the communication frame including the control message transmitted from the upper-level control device to reach the lower-level control device,

the control method comprising:

the upper-level control device repeatedly transmitting the communication frame including the control message to the at least two or more communication paths over time, wherein each communication frame includes identification information used to identify an ordinal of the communication frame in a transmitting order;

the lower-level control device determining based on the identification information of the received communication frame whether or not the ordinal of the received communication frame in the transmitting order is the same as or older than that of the previously received communication frame; and

the lower-level control device performing processes such that:

upon determining that the ordinal of the received communication frame in the transmitting order is not the same as nor older than that of the previously received communication frame but is newer than that of the previously received communication frame, the lower-level control device executes the control process based on the control message included in the received communication frame; and

upon determining that the ordinal of the received communication frame in the transmitting order is the same as or older than that of the previously received communication frame, the lower-level control device does not execute the control process based on the control message included in the received communication frame.

According to the in-vehicle communication system and the control method of the in-vehicle communication system according to the present disclosure, one or more communication lines are connected between the upper-level control device, the middle-level control device and the lower-level control device so that at least two or more communication paths are present each for the communication frame including the control message transmitted from the upper-level control device to reach the lower-level control device. Therefore, even if an abnormality of communication failure occurs in any one of that communication paths, the lower-level control device can still receive the communication frame including the control message via the communication path that is normal. This increases a possibility that the communication frame including the control message reaches the lower-level control device.

According to the in-vehicle communication system and the control method of the in-vehicle communication system according to the present disclosure, the lower-level control device determines whether or not the ordinal of the received communication frame in the transmitting order is the same as or older than that of the previously received communication frame, based on the identification information of the received communication frame. Upon determining that the ordinal of the received communication frame in the transmitting order is not the same as nor older than that of the previously received communication frame but is newer than that of the previously received communication frame, the lower-level control device executes the control process based on the control message included in the received communication frame. Upon determining that the ordinal of the received communication frame in the transmitting order is the same as or older than that of the previously received communication frame, the lower-level control device does not execute the control process based on the control message included in the received communication frame. In this configuration, inappropriate control execution according to the control message included in the communication frame older than the previously received communication frame can be prevented.

Preferred embodiments of an in-vehicle communication system and a control method of the in-vehicle communication system of the present disclosure will be described with reference to the drawings. The present disclosure is not limited to the following multiple embodiments, and various modifications described below are also included in the technical scope of the present disclosure. The multiple embodiments and various modification may be combined as appropriate to the extent that no technical contradiction arises. In the following description, like components may be denoted like reference symbol throughout the drawings, and descriptions thereof may be omitted. In addition, in a case where only part of the configuration is referred to in an embodiment or modification, the foregoing description may be applied to the remaining configuration.

### First Embodiment

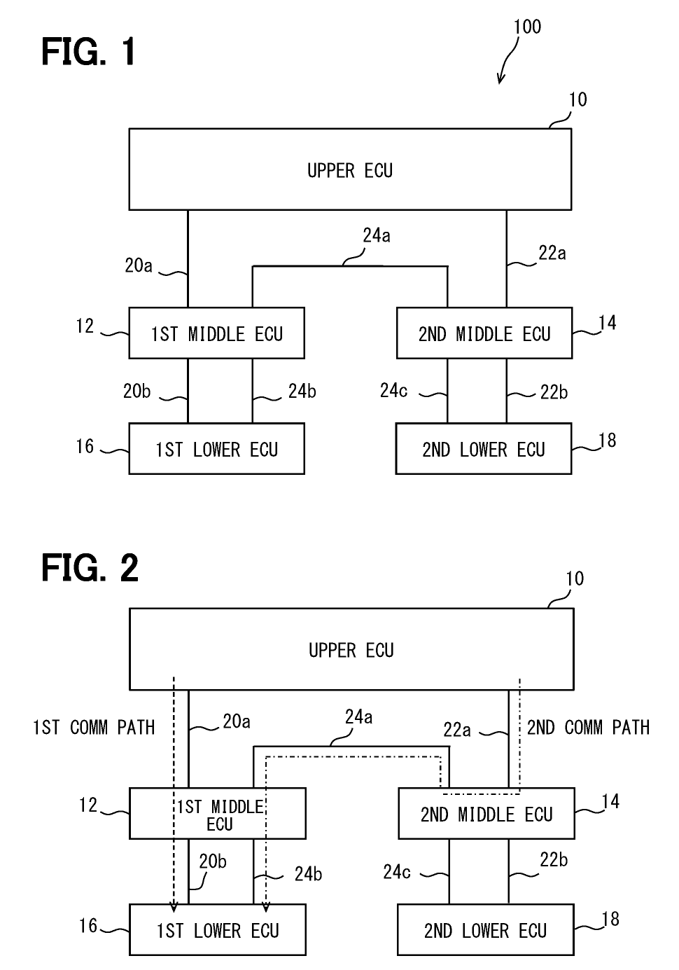

FIG. 1 shows an example configuration of an in-vehicle communication system 100. The in-vehicle communication system 100 shown in FIG. 1 includes a upper-level ECU 10 as a upper-level control device, first and second middle-level ECUs 12, 14 as first and second middle-level control devices, and first and second lower-level ECUs 16, 18 as first and second lower-level control devices. ECU is an abbreviation for Electronic Control Unit. In the present embodiment, the upper-level ECU 10, the first and second middle-level ECUs 12, 14, and the first and second lower-level ECUs 16, 18 are mounted on a vehicle. The in-vehicle communication system 100 may be applied to a system for controlling an important function of a vehicle, e.g., at least one of a drive system, a steering system, and a braking system of the present embodiment. Examples of the vehicle include passenger cars, motorcycles, transportation vehicles, construction vehicles, agricultural vehicles, and military vehicles.

The configuration of the in-vehicle communication system 100 is not limited to the example shown in FIG. 1. For example, the number of upper-level ECUs 10 is not limited to one and may be two or more. In this case, the middle-level ECU and the lower-level ECU may be arranged in a level lower than a respective upper-level ECU. The two or more upper-level ECUs 10 may be communicably connected to each other. The number of middle-level ECU 12, 14 arranged in a level lower than the upper-level ECU 10 is not limited to two and may be one, or three or more. As for the lower-level ECUs 16, 18, two or more lower-level ECUs may be connected to a single middle-level ECU 12, 14.

The upper-level ECU 10, the first and second middle-level ECUs 12, 14, and the first and second lower-level ECUs 16, 18 each include a computer including a processor, a memory, and a storage. For example, the processor is a CPU (Central Processing Unit), an MPU (Micro Processing Unit), a GPU (Graphics Processing Unit), a DFP (Data Flow Processor), or the like, each of which is capable of executing a given process according to a program. The memory is a volatile storage medium such as a RAM (Random Access Memory), which temporarily stores results of computational processing executed by the processor. The storage is a non-volatile storage medium, such as flash memory or ROM (i.e., Read Only Memory). The storage stores various data and programs executed by the processor.

Part or all of the functions provided by the upper-level ECU 10, the first and second middle-level ECUs 12 and 14, and the first and second lower-level ECUs 16, 18 may be implemented not by software such as a program, but by hardware, for example, using an ASIC (Application Specific Integrated Circuit), an FPGA (Field-Programmable Gate Array) etc.

The upper-level ECU 10, the first and second middle-level ECUs 12, 14, and the first and second lower-level ECUs 16, 18 are configured to communicate with each other and with other ECUs via communication buses 20a, 20b, 22a, 22b, 24a, 24b, 24c. Specifically, the upper-level ECU 10, the first and second middle-level ECUs 12, 14, and the first and second lower-level ECUs 16, 18 each include a communication interface (not shown) to communicate with another ECU.

More specifically, the upper-level ECU 10 is communicably connected to the first middle-level ECU 12 via the communication bus 20a. The upper-level ECU 10 is communicably connected to the second middle-level ECU 14 via the communication bus 22a. The first middle-level ECU 12 is communicably connected to the second middle-level ECU 14 via the communication bus 24a. The first middle-level ECU 12 is communicably connected to the first lower-level ECU 16 via the communication bus 20b corresponding a first communication line and the communication bus 24b corresponding to a second communication line. Like the first medium ECU 12, the second medium ECU 14 is also communicably connected to the second lower ECU 18 via the communication bus 22b and the communication bus 24c.

The in-vehicle communication system 100 can use CAN (registered trademark, hereinafter the same) as a communication protocol for the upper-level ECU 10, the first and second middle-level ECUs 12, 14, and the first and second lower-level ECUs 16, 18 to communicate with each other. CAN is an abbreviation of Controller Area Network. The communication protocol is not limited to CAN, and the in-vehicle communication system 100 can employ various communication protocols such as Ethernet (registered trademark, the same below), LIN (Local Interconnect Network), FlexRay (registered trademark), CAN-FD (CAN with FlexRay (registered trademark), CAN-FD (CAN with Flexible Data Rate).

Furthermore, different communication protocols may be employed for different communication buses 20a, 20b, 22a, 22b, 24a, 24b, 24c. For example, Ethernet may be used for communication buses 20a, 20b, 22a, 22b and CAN may be used for communication buses 24a, 24b, 24c.

The upper-level ECU 10 can, for example, function as a domain controller, which supervises controls of the first and second middle-level ECUs 12, 14 and the first and second lower-level ECUs 16, 18. A domain refers to a functional unit when vehicle functions are divided broadly. For example, a powertrain domain, a chassis domain, an advanced driver assistance domain, a body domain, a cockpit domain, and the like may be present. For example, when the upper-level ECU 10 is a powertrain domain controller, the first, second lower-level ECUs 16 and 18 include various ECUs for controlling the powertrain of the vehicle, such as an engine ECU, a motor (inverter) ECU, a battery monitoring ECU, a transmission ECU, etc. When the upper-level ECU 10 is the domain controller of the chassis domain, the first, second lower-level ECUs 16 and 18 include various ECUs for chassis control of the vehicle, such as a steering ECU, a brake ECU, and a suspension ECU.

The drive system may include the ECUs in the powertrain domain and actuators controlled by these ECUs. The steering system and the braking system each include at least one ECU in the chassis domain and an actuator controlled by the ECU. The above is an example of domain classification, and the domain classification may differ from the above example. For example, the chassis domain may be divided into a steering domain and a braking domain.

The upper-level ECU 10 repeatedly generates a control message for each lower-level ECU 16, 18 over time based on information acquired from a sensor and another ECUs (e.g., accelerator position, brake pedal operation, shift position, steering operation, vehicle speed, engine speed, motor speed, remaining battery level, etc.). The control message commands a control content to be executed. Each time the control message is generated for a respective lower-level ECUs 16 and 18, the upper-level ECU 10 generates a communication frame that includes the generated control message, an identifier indicating the relay destination of the generated control message and identification information used to identify an ordinal of the control message in an order in which control messages are generated (transmitting order). The identification information may be, for example, a serial number that changes (increases or decreases) by a certain value per control message transmission or may be a time stamp indicating the time of transmission.

Here, when the in-vehicle communication system 100 is applied to a system for controlling an important function of a vehicle, such as the drive system, the steering system, the braking system of the vehicle etc., consideration should be given to ensure that the communication frame including the control message reaches the first, second lower-level ECU 16, 18. Therefore, in the present embodiment, the in-vehicle communication system 100 is configured such that the upper-level ECU 10 transmits the communication frame including the control message toward the first, second lower-level ECU 16, 18 via two different communication paths. In this configuration, even if an abnormality of communication failure occurs in one communication path, the first, second lower-level ECU 16, 18 can receive the communication frame including the control message via the other normal communication path. As a result, a possibility that the communication frame including the control message reaches the first, second lower-level ECU 16, 18 can be increased. The in-vehicle communication system 100 may be configured such that the communication frame including the control message is transmitted from the upper-level ECU 10 to the first, second lower-level ECU 16, 18 via three or more different communication paths.

For example, in the in-vehicle communication system 100 with the configuration shown in FIG. 1, when the upper-level ECU 10 transmits the communication frame including the control message to the first lower-level ECU 16, the upper-level ECU 10 can transmit the communication frame to the first lower-level ECU 16 via the first communication path shown in FIG. 2 by the dotted line and the second communication path shown in FIG. 2 by a one-dotted-dashed line. The first communication path is a path from the upper-level ECU 10 to the first lower-level ECU 16 via the communication bus 20a, the first middle-level ECU 12, and the communication bus 20b. The second communication path is a path from the upper-level ECU 10 to the first lower-level ECU 16 via the communication bus 22a, the second middle-level ECU 14, the communication bus 24a, the first middle-level ECU 12, and the communication bus 24b. In the in-vehicle communication system 100 with the configuration shown in FIG. 1, the upper-level ECU 10 can also transmit the communication frame including the control message to the second lower-level ECU 18 via two different communication paths.

When the upper-level ECU 10 transmits the communication frame including the control message toward the first lower-level ECU 16, the upper-level ECU 10 can transmit the communication frame to the first communication path and the second communication path at substantially the same time period. In this case, the communication frame transmitted by the upper-level ECU 10 to the first communication path and the communication frame transmitted to the second communication path have the same control message and the same identification information but have different identifiers. This is because the first and second communication paths are different from each other in which communication bus is the communication frame destination of the relay at the first, second middle-level ECU 12, 14.

The communication frame including the control message repeatedly transmitted from the upper-level ECU 10 is relayed (gatewayed) by the first, second middle-level ECU 12,14 to its subordinate which is the first, second lower-level ECU 16, 18 based on the identifier added in the communication frame. The first, second middle-level ECU 12, 14 also has the function of relaying to the upper-level ECU 10 a communication frame transmitted from its subordinate which is the first, second lower-level ECU 16, 18, based on the identifier added in the communication frame.

More specifically, the first, second middle-level ECU 12, 14 has a relay destination table that indicates the correspondence between the identifier added in the communication frame and the communication bus to which the communication frame is relayed. The first, second middle-level ECU 12, 14 determines whether or not it is necessary to relay the received communication frame, by referring to the relay destination table. Upon determining that it is necessary to relay, the first, second middle-level ECU 12, 14 relays the communication frame to the communication bus that is specified using the relay destination table. The first, second middle-level ECU 12, 14 performs protocol conversion when the communication protocol in the communication bus from which the communication frame is received is different from the communication protocol in the communication bus to which the communication frame is transmitted.

The first, second lower-level ECU 16, 18 is, for example, a control ECU that controls a given control object in the vehicle, a sensor ECU that calculates a given physical quantity based on a detection signal detected by a sensor, or a drive ECU that outputs a drive signal to an actuator to drive the actuator. The first, second lower-level ECU 16, 18 executes a control process according to the control message from the upper-level ECU 10, such as controlling the control target, calculating the physical quantity, and driving the actuator.

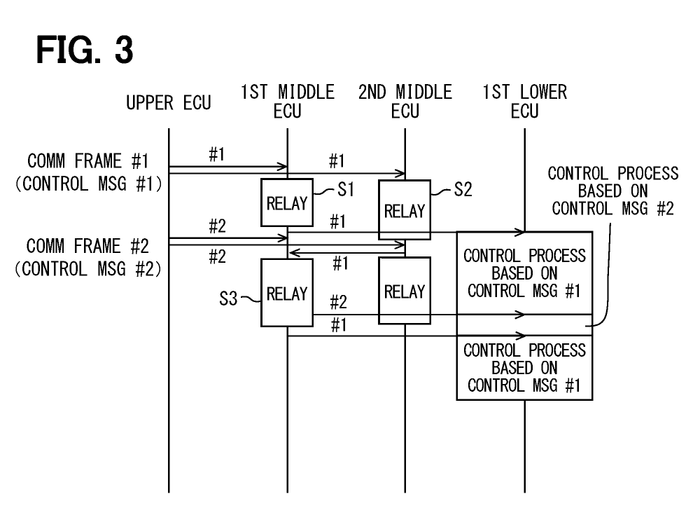

As described above, transmission by the upper-level ECU 10 of the communication frames including the control messages to a respective first, second lower-level ECU 16, 18 via two or more different communication paths does not necessarily mean that the communication frames including the control messages reach the respective first, second lower-level ECU 16, 18 in the order in which the communication frames are transmitted. For example, it is conceivable that a communication frame including an older control message transmitted earlier may reach the first, second lower-level ECU 16, 18 later than a communication frame including a newer control message transmitted later. In this case, execution by the first, second lower-level ECU 16, 18 of the control process according to the older control message may cause a difficulty in performing optimal control according to vehicle state or the like. This will be described more specifically with respect to FIG. 3. FIG. 3 shows an example where the upper-level ECU 10 transmits the communication frame including the control message to the first lower-level ECU 16 via the first communication path and the second communication path.

In FIG. 3, the upper-level ECU 10 transmits the communication frame (communication frame #1) of which the ordinal in the transmitting order is the first, including the control message (control message #1) of which the ordinal is the first, to the first communication path and the second communication path at the same time period. That is, the upper-level ECU 10 transmits the multiple communication frames (communication frames #1) of which the ordinal in the transmitting order is the same and the control message is the same to the multiple communication paths at the same time period. The communication frame #1 transmitted to the first communication path is received by the first middle-level ECU 12 via the communication bus 20a. The first middle-level ECU 12 relays the received communication frame #1 to the communication bus 20b by the relay process S1. The communication frame #1 is then received by the first lower-level ECU 16. Upon receipt of the communication frame #1, the first lower-level ECU 16 executes the control process according to the control message #1.

The communication frame #1 transmitted to the second communication path is received by the second middle-level ECU 14 via the communication bus 22a. The second middle-level ECU 14 relays the received communication frame #1 to the communication bus 24a by the relay process S2. The communication frame #1 is then received by the first middle-level ECU 12 via the communication bus 24a. Then, the first middle-level ECU 12 relays the received communication frame #1 to the communication bus 24b by the relay process S3. Then the communication frame #1 is received by the first lower-level ECU 16 again.

As shown in FIG. 3, for example, the upper-level ECU 10 transmits the communication frame (communication frame #2) of which the ordinal in the transmitting order is the second, including the control message (control message #2) of which the ordinal is the second, to the first communication path and the second communication path at the same time period, upon elapse of a certain time since the transmission of the communication frame #1. That is, the upper-level ECU 10 transmits the multiple communication frames (communication frames #2) of which the ordinal in the transmitting order is the same and the control message is the same to the multiple communication paths at the same time period The communication frame #2 transmitted to the first communication path is received by the first middle-level ECU 12 via the communication bus 20a, similarly to the communication frame #1. The received communication frame #2 is then relayed to the communication bus 24b by the relay process S3 of the first middle-level ECU 12 and received by the first lower-level ECU 16.

The communication frame #2 is transmitted later than the communication frame #1. Nevertheless, as shown in FIG. 3, it can happen that the communication frame #1 transmitted via the second communication path is received by the first lower-level ECU 16 later than communication frame #2 transmitted via the first communication path. In this case, the optimal control is difficult if, during executing the control process according to the control message #2 in communication frame #2, the lower-lower-level ECU 16 executes the control process according to the control message #1 in response to receiving the communication frame #1 having the identification information different from that of the communication frame #2.

A discrepancy shown in FIG. 3 between an order in which the upper-level ECU 10 transmits the communication frames and an order in which the first lower-level ECU 16 receives the communication frames can be caused by such factors as a difference in path length between the multiple communication paths, a difference in hardware and/or software relay performance between the middle-level ECUs 12, 14, a difference in the number of relay processes performed by the middle-level ECUs 12, 14, a difference in communication load state between multiple communication paths, a differences in speed between communication protocols used for communications in multiple communication paths, etc. Therefore, when the upper-level ECU 10 transmits the communication frame including the control message to the respective first, second lower-level ECU 16, 18 via multiple communication paths, it is required to take measures against the discrepancy between the transmitting order and the receiving order.

Therefore, in the in-vehicle communication system 100 of the present embodiment, each of the first, second lower-level ECUs 16, 18 is configured to determine, based on the identification information added in the received communication frame, whether or not the ordinal of the received communication frame in the transmitting order is the same as or older than that of the communication frame previously received. The first, second lower-level ECUs 16, 18 is configured such that, upon determining that the ordinal of the received communication frame in the transmitting order is not the same as nor older than that of the communication frame previously received but is newer than that of the communication frame previously received, the first, second lower-level ECUs 16, 18 executes the control process based on the control message included in the received communication frame. Upon determining that the ordinal of the received communication frame in the transmitting order is the same as or older than that of the communication frame previously received, the first, second lower-level ECUs 16, 18 does not execute the control process based on the control message included in the received communication frame. Because of this, the inappropriate control execution according to the control message included in the communication frame older in the transmitting order than the previously received communication frame can be prevented.

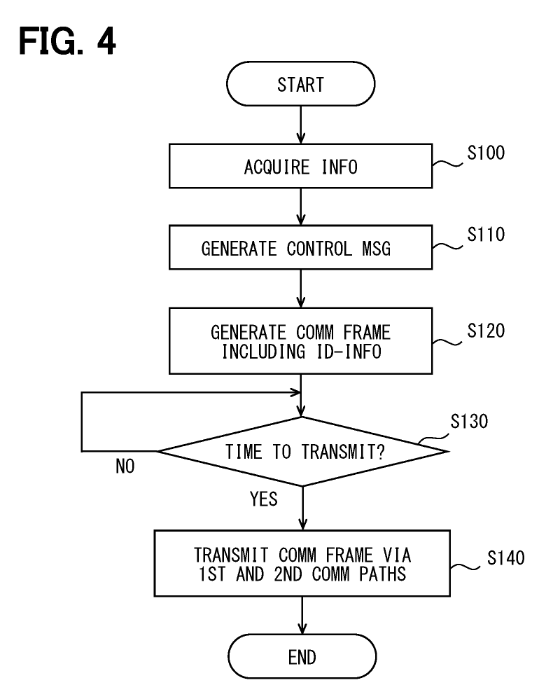

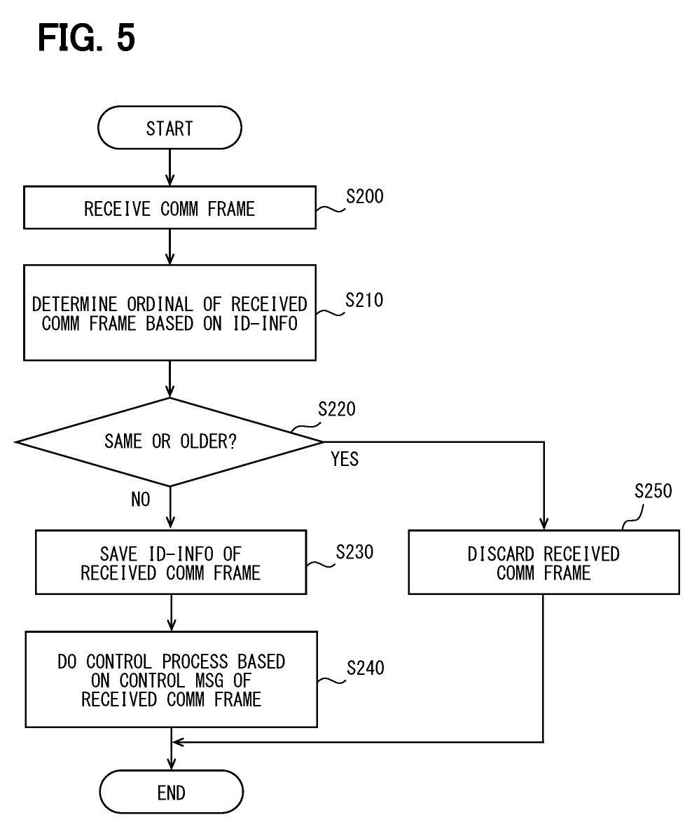

The following describes processes related to transmission of communication frames by the upper-level ECU 10 and receipt of communication frames by the first, second lower-level ECU 16, 18 of the in-vehicle communication system 100 of the present embodiment, with reference to the flowcharts in FIGS. 4 and 5. Execution of the processes of the flowchart in FIG. 4 by the upper-level ECU 10 and execution of the processes of flowchart in FIG. 5 by the first, second lower-level ECU 16, 18 correspond to execution of a control method of the in-vehicle communication system 100 of the present disclosure.

First, with reference to the flowchart in FIG. 4, the processes related to the transmission of communication frames by the upper-level ECU 10 will be described. The upper-level ECU 10 may execute the processes shown in the flowchart of FIG. 4 individually for each of the first, second lower-level ECUs 16 and 18 at given cycles, for example. The following will describe an example in which the upper-level ECU 10 executes control processes for transmission of communication frames to the first lower-level ECU 16.

In step S100, the upper-level ECU 10 acquires the information from a sensor and another ECU (e.g., accelerator opening, brake pedal operation amount, shift position, steering operation amount, vehicle speed, engine speed, motor speed, and remaining battery level) to generate the control message. In step S110, the upper-level ECU 10 generates the control message that instructs the control content to be executed by the first lower-level ECU 16 based on the information acquired in step S100.

In step S120, the upper-level ECU 10 generates the communication frame in which the identifier indicating the relay destination of the control message and the identification information used to identify the ordinal of the communication frame in the order in which the control messages are generated (transmitting order) are added to the control message generated in step S110. As described above, the identification information differs for each communication frame (control message) transmission so that the ordinal in the transmitting order can be identified.

In step S130, the upper-level ECU 10 determines whether or not the time for transmission of the current communication frame has arrived based on whether or not a certain amount of time has elapsed since the transmission of the previous communication frame. If it is determined that the time for transmission of the current communication frame has arrived, the upper-level ECU 10 proceeds to step S140. On the other hand, if it is determined that the time for transmission of the current communication frame has not arrived, the upper-level ECU 10 repeats the process of step S130 to wait for the time for transmission.

In step S140, the upper-level ECU 10 transmits the communication frame generated in step S120 toward the first lower-level ECU 16 via the first communication path and the second communication path at the same time period. That is, the upper-level ECU 10 transmits the multiple communication frames of which the ordinal in the transmitting order is the same via the first and second communication paths at the same time period. The communication frames transmitted at the same time period via the first and second communication paths include the same control message and the same identification information.

Next, referring to the flowchart in FIG. 5, the processes related to receipt of communication frames by the first, second lower-level ECU 16, 18 will be described. The series of processes shown in the flowchart in FIG. 5 is executed at given cycles for each of the first and second lower-level ECUs 16 and 18, for example. The following will describe an example in which the first lower-level ECU 16 performs the processes related to the receipt of communication frames.

In step S200, the first lower-level ECU 16 receives the communication frame including the control message via the communication buses 20b and 24b. In step S210, the first lower-level ECU 16 determines the ordinal of the received communication frame in the transmitting order based on the identification information of the received communication frame. More specifically, the identification information of the newest communication frame among the previously received communication frames including the control messages is saved in the first lower-level ECU 16 (cf. step S230 described below). In step S210, the first lower-level ECU 16 determines whether or not the ordinal of the received communication frame in the transmitting order is the same as or older than that of the previously received communication frame based on the received communication frame identification information and the saved identification information.

In step S220, the first lower-level ECU 16 executes a branching process based on the result of the determination in step S210. Specifically, if the result of the determination in step S210 indicates that the ordinal of the received communication frame in the transmitting order is neither the same as nor older than that of the previously-received communication frame, but is newer than that of the previously-received communication frame, the first lower-level ECU 16 proceeds to step S230. On the other hand, if the result of the determination in step S210 indicates that the ordinal of the received communication frame in the transmitting order is the same as or older than that of the previously received communication frame, the first lower-level ECU 16 proceeds to step S250.

In step S230, the first lower-level ECU 16 saves the identification information of the communication frame received in step S200 in the memory. If there is the identification information saved before, the first lower-level ECU 16 updates the identification information by overwriting it with the new identification information. In this way, the saved or updated identification information is the identification information of the communication frame of which the ordinal is newest (largest) in the transmitting order among the communication frames received at the first lower-level ECU 16. In step S240, the first lower-level ECU 16 executes the control process according to the control message of the received communication frame. The first lower-level ECU 16 then ends the processes shown in the flowchart in FIG. 5.

The communication frame when the process of step S250 is executed is such that the ordinal in the transmitting order of the communication frame received in step S200 is the same as or older than that of the communication frame previously received. In step S250, the first lower-level ECU 16 discards the received communication frame without executing the control process according to the control message of the communication frame. The first lower-level ECU 16 then ends the processes shown in the flowchart of FIG. 5.

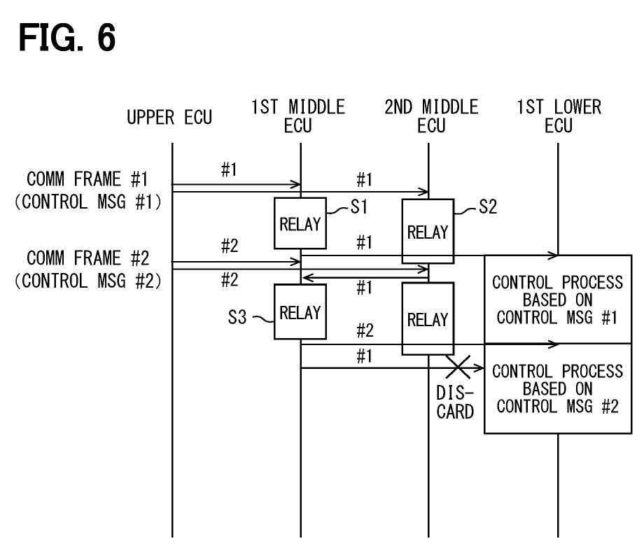

The operations and effects of the above-mentioned processes related to the transmission of communication frame by the upper-level ECU 10 and the receipt of communication frame by the first, second lower-level ECUs 16,18 will be described with reference to the sequence diagram in FIG. 6. FIG. 6 also shows an example where the upper-level ECU 10 transmits the communication frame including the control message to the first lower-level ECU 16 via the first, second communication paths.

As shown in FIG. 6, the upper-level ECU 10 transmits the communication frames (communication frames #1) of which the ordinal in the transmitting order is the first, including the control message (control message #2) of which the ordinal is the second, to the first communication path and the second communication path at the same time period. The communication frame #1 transmitted to the first communication path is received by the first middle-level ECU 12 via the communication bus 20a. The received communication frame #1 is then relayed to the communication bus 20b by the relay process S1 of the first middle-level ECU 12 and received by the first lower-level ECU 16. Upon receipt of the communication frame #1, the first lower-level ECU 16 executes the control process according to the control message #1.

The communication frame #1 transmitted to the second communication path is received by the second middle-level ECU 14 via the communication bus 22a. The second middle-level ECU 14 relays the received communication frame #1 to the communication bus 24a by the relay process S2. The communication frame #1 is then received by the first middle-level ECU 12 via the communication bus 24a. The first middle-level ECU 12 relays the received communication frame #1 to the communication bus 24b by the relay process S3. As a result, the communication frame #1 transmitted to the second communication path is received by the first lower-level ECU 16.

As shown in FIG. 6, the upper-level ECU 10 transmits the communication frames (communication frames #2) of which the ordinal is the second, including the control message (control message #2) of which the ordinal is second, to the first and second communication paths at the same time period, in response to the elapse of a certain time since the transmission of the communication frame #1. The communication frame #2 transmitted to the first communication path is received by the first middle-level ECU 12 via the communication bus 20a, similarly to the communication frame #1. The received communication frame #2 is then relayed to the communication bus 24b by the relay process S3 of the first middle-level ECU 12 and received by the first lower-level ECU 16. The first lower-level ECU 16 executes the control process according to the control message #2 in response to the receipt of the communication frame #2.

Now let us assume that, as shown in FIG. 6, the first lower-level ECU 16 receives the communication frame #2 via the first communication path and thereafter receives the communication frame #1 via the second communication path. In the in-vehicle communication system 100, in response to receiving the communication frame #1, the first lower-level ECU 16 determines, based on the identification information of the communication frame #1, whether the ordinal of the communication frame #1 in the transmitting order is the same as or older than that of the previously-received communication frame #2. The identification information of the communication frame #1 indicates an older ordinal in the transmitting order than that of the communication frame #2. Therefore, the first lower-level ECU 16 discards the received communication frame #1 without executing the control process according to the control message in the communication frame #1.

As seen from the above, in the in-vehicle communication system 100 of the present embodiment, the first lower-level ECU 16 does not execute the control process based on the control message of the received communication frame, not only in a case where it is determined based on the identification information of the received communication frame that the ordinal of the received communication frame in the transmitting order is the same as that of the previously received communication frame but also in a case where it is determined that the ordinal in the transmitting order is older than that of the previously received communication frame. Therefore, according to the in-vehicle communication system 100, unnecessary process based on the control message in the communication frame of which the ordinal in the transmitting order is the same as the previously received communication frame is avoidable. In addition, according to the in-vehicle communication system 100 according to the present embodiment, inappropriate control execution according to the control message in the communication frame older than the previously received communication frame can be prevented.

### Second Embodiment

Next, the in-vehicle communication system 100 of the second embodiment of the present disclosure will be described with reference to the drawings. The in-vehicle communication system 100 may be configured similarly to the in-vehicle communication system 100 of the first embodiment, so that the description of the configuration is omitted.

In the in-vehicle communication system 100 of the first embodiment, the upper-level ECU 10 transmits the communication frame to the first communication path and the second communication path shown in FIG. 2 at substantially the same time period when transmitting the communication frame including the control message to the lower-level ECU 16, for example.

In contrast, the in-vehicle communication system 100 of the present embodiment is configured such that in the repeated transmission by the upper-level ECU 10 of the communication frame including the control message to a respective first, second lower-level ECU 16,18, the upper-level ECU 1 transmits the communication frame via a single communication path which is switched over per communication frame transmission in a predetermined order among the two or more communication paths.

In the in-vehicle communication system 100 of the present embodiment, the communication path for transmitting the communication frame is thus switched over per communication frame transmission. Because of this, if an abnormality occurs in any of the two or more communication paths to the first lower-level ECU 16 for example, the communication frame including the control message can reach the first lower-level ECU 16 being a destination via the communication path that is normal. Therefore, as in the first embodiment, it is possible to increase the possibility that the communication frame including the control message reaches the first, second lower-level ECU 16, 18. If one of the communication paths fails, each of the first, second lower-level ECUs 16 and 18 cannot receive the communication frames from the failed communication path. In this case, although each of the first and second lower-level ECUs 16 and 18 can acquire the control messages except the control message in the unreceivable communication frame, each of the first and second lower-level ECUs 16 and 18 can still continue the control processes based on the acquired control message.

Furthermore, according to the in-vehicle communication system 100, the communication frame including the control message is transmitted via a single communication path that is switched over among two or more communication paths. This makes it possible to reduce the communication load on each communication bus as compared to the case where the communication frame including the control message is transmitted via multiple communication paths at the same time period.

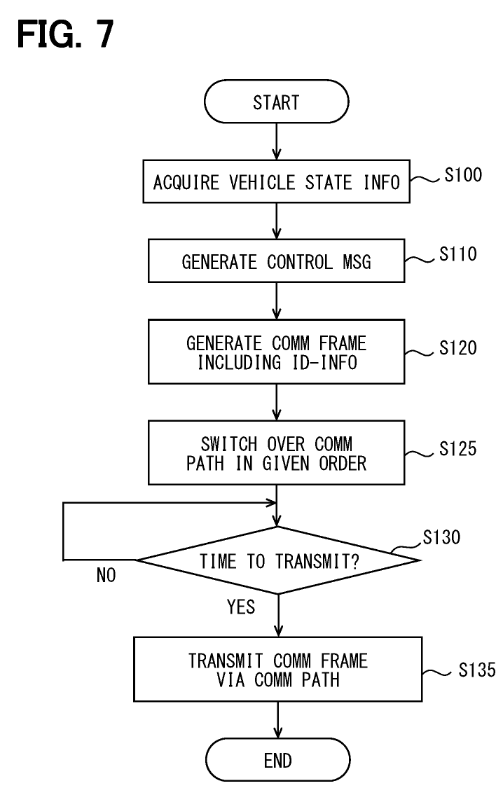

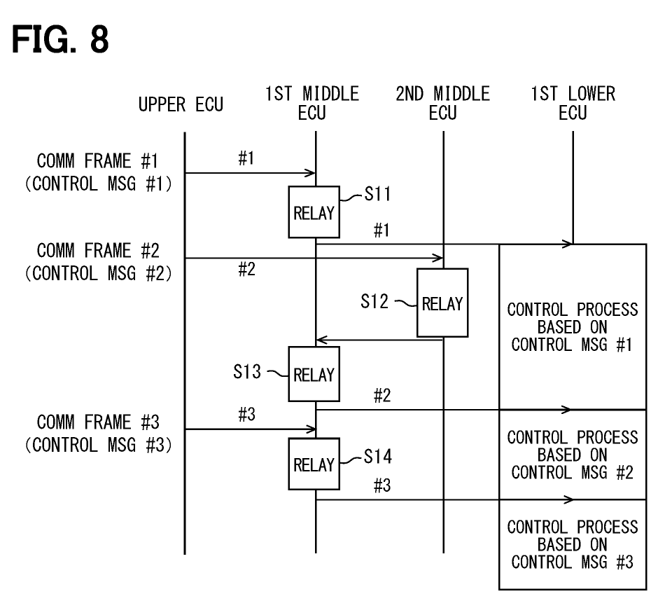

Referring to FIGS. 7 and 8, the communication frame transmission process executed by the upper-level ECU 10 of the in-vehicle communication system 100 of the present embodiment will be described. FIG. 7 is a flowchart showing the processes related to the transmission of communication frames by the upper-level ECU 10. The following description regarding FIG. 7 describes an example in which the upper-level ECU 10 executes the process related to the transmission of communication frames to the first lower-level ECU 16. FIG. 8 shows a sequence diagram of an example in which the upper-level ECU 10 transmits the communication frames including the control message to the first lower-level ECU 16 via the first, second communication paths. The processes related to the receipt of communication frames executed by the first, second lower-level ECU 16, 18 of the in-vehicle communication system 100 are the same as those of the first embodiment, so that the description is omitted.

The processes of steps S100-S120 and S130 in the flowchart in FIG. 7 are the same as the processes of steps S100-S120 and S130 in the flowchart in FIG. 4, so that the description is omitted.

In step S125 of the flowchart in FIG. 7, the upper-level ECU 10 switches over the communication path for transmitting the communication frame including the control message among the two or more communication paths to the first lower-level ECU 16 in a given order. In this case, it is preferable to switch over the communication path so that the communication frame transmission frequencies of the communication paths are equal to each other.

For example, in a case where the first communication path and the second communication path are, as shown in FIG. 2, the communication path to the first lower-level ECU 16, the upper-level ECU 10 can alternately switch over the communication path between the first, second communication paths per transmission of the communication frame including the control message. The sequence diagram in FIG. 8 shows an example in which the upper-level ECU 10 alternately switches over the communication path among the first, second communication paths for each transmission of the communication frame including the control message. Alternatively, for example, in a case in which there are three communication paths to the first lower-level ECU 16 which are the first communication path, the second communication path and the third communication path, the upper-level ECU 10 can switch over the communication path so that switching over in the order from the first communication path, the second communication path and the third communication path for each transmission of the communication frame including the control message is repeated.

In step S135 of the flowchart in FIG. 7, the upper-level ECU 10 transmits the communication frame including the control message via one of the communication paths, where the one of the communication paths is a communication path as a result of switching over. Thereafter, the upper-level ECU 10 ends the processes shown in the flowchart in FIG. 7.

In FIG. 8, the upper-level ECU 10 transmits the communication frame (communication frame #1), of which the ordinal is the first, including the control message (control message #1) of which the ordinal is the first, to the first communication path. The communication frame #1 transmitted to the first communication path is received by the first middle-level ECU 12 via the communication bus 20a. The received communication frame #1 is then relayed to the communication bus 20b by the relay process S11 of the first middle-level ECU 12 and received by the first lower-level ECU 16. Upon receipt of communication frame #1, the first lower-level ECU 16 executes the control process according to the control message #1.

As shown in FIG. 8, the upper-level ECU 10 transmits the communication frame (communication frame #2) of which the ordinal is the second, including the control message (control message #2) of which the ordinal is the second, to the second communication path in response to the elapse of a certain time since the transmission of the communication frame #1. The communication frame #2 transmitted to the second communication path is received by the second middle-level ECU 14 via the communication bus 22a. The received communication frame #2 is relayed to the communication bus 24a by the relay process S12 of the second middle-level ECU 14 and received by the first middle-level ECU 12. Furthermore, the communication frame #2 is relayed to the communication bus 24b by the relay process S13 of the first middle-level ECU 12 and received by the first lower-level ECU 16. The first lower-level ECU 16 executes the control process according to the control message #2 in response to the receipt of the communication frame #2.

The upper-level ECU 10 transmits the communication frame (communication frame #3) of which the ordinal is the third, including the control message (control message #3) of which the ordinal is the third, to the first communication path in response to the elapse of a certain time since transmission of the communication frame #2. The communication frame #3 transmitted to the first communication path is received by the first lower-level ECU 16 via the communication bus 20a, the first middle-level ECU 12, and the communication bus 20b, like the communication frame #1. In response to receipt of the communication frame #3, the first lower-level ECU 16 executes the control process according to the control message #3.

In the above example, the upper-level ECU 10 transmits the communication frames including the control messages at regular time intervals. However, the upper-level ECU 10 may change the transmission interval of the communication frame including the control message according to the estimated time for the communication frame including the control message to reach the lower-level ECU 16, 18 in the switched-over communication path.

For example, in the case where the communication path to the first lower-level ECU 16 is alternately switched over between the first communication path and the second communication path shown in FIG. 2, the time interval from transmitting the communication frame to the first communication path to transmitting the communication frame to the second communication path may be shorter than the time interval from transmitting the communication frame to the second communication path to transmitting the communication frame to the first communication path.

The second communication path is greater than the first communication path in path length and furthermore in the number of relays by the middle-level ECU 12, 14. It is therefore considered that the time for the communication frame including the control message to reach the first lower-level ECU 16 via the second communication path is longer than that via the first communication path. Accordingly, the time interval control is performed so that a time interval from transmitting the communication frame to the first communication path to transmitting the communication frame to the second communication path is shorter than the time interval from transmitting the communication frame to the second communication path to transmitting the communication frame to the first communication path. Accordingly, the time intervals of receipt of the communication frames at the first lower-level ECU 16 can become similar to or equal.

### Third Embodiment

Next, the in-vehicle communication system 100 of the third embodiment of the present disclosure will be described with reference to the drawings. The in-vehicle communication system 100 may be configured similarly to the in-vehicle communication system 100 of the first embodiment, so that the description of the configuration is omitted.

In the in-vehicle communication system 100 of the present embodiment, an alive check communication frame (i.e., communication frame for alive check) is periodically and mutually transmitted and received between the upper-level ECU 10 and the first, second middle-level ECU 12, 14, between the first middle-level ECU 12 and the second middle-level ECUs 12, 14, and between the first, second middle-level ECU 12, 14 and its subordinate which is the first, second lower-level ECU16, 18.

The upper-level ECU 10 and the first, second middle-level ECU 12, 14 have an abnormality detection function which determines occurrence of an abnormality in the communication path based on a result of receiving the alive check communication frame. Specifically, the upper-level ECU 10 and the first, second middle-level ECU 12, 14 have an abnormality detection function which, when failing to receive the alive check communication frame from an ECU connected via a communication bus, determines that an abnormality has occurred in the communication path that includes the communication bus and the ECU. Upon detecting the abnormality, the upper-level ECU 10 and the first, second middle-level ECU 12, 14 stop use of the communication path in which the abnormality occurrence is determined.

For example, upon failing to receive the alive check communication frame from either one of the first middle-level ECU 12 and the second middle-level ECU 14, the upper-level ECU 10 stops use of the communication path that includes the one of the first middle-level ECU 12 and the second middle-level ECU 14. When the communication frame including the control message is generated that should be transmitted via the communication path of which the use is stopped, the upper-level ECU 10 executes transmission of the communication frame including the control message by using the communication path that includes the other of the first middle-level ECU 12 and the second middle-level ECU 14.

For example, if, from one of the communication bus 20b and the communication bus 24b, the first middle-level ECU 12 fails to receive the alive check communication frame from the subordinate which is the first lower-level ECU 16, the first middle-level ECU 12 stop use of the one of the communication bus 20b and the communication bus 24b. When the first middle-level ECU 12 has the communication frame including the control message that should be transmitted via the one of the communication buses 20b and 24b of which the use is stopped, the first middle-level ECU 12 uses the other of the communication buses 20b and 24b to transmit the communication frame including the control message.

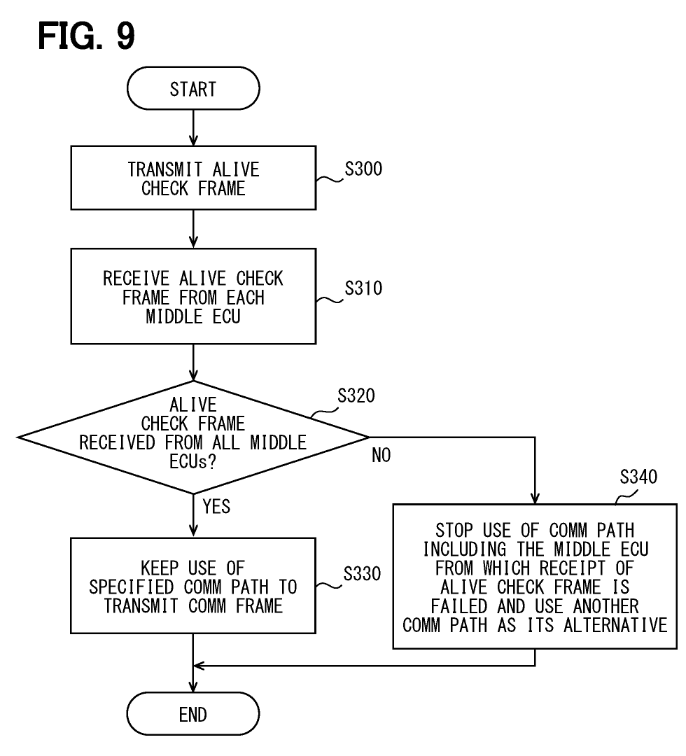

Next, the communication path abnormality detection function of the upper-level ECU 10 will be more specifically described. FIG. 9 shows a flowchart of processes executed by the upper-level ECU 10 for abnormality detection. The upper-level ECU 10 executes the processes shown in the flowchart in FIG. 9 at given time intervals.

In step S300, the upper-level ECU 10 transmits the alive check communication frame to the first, second middle-level ECU 12, 14 via the communication bus 20a and the communication bus 22a. By receiving the alive check communication frame from the upper-level ECU 10, the first, second middle-level ECUs 12, 14 successfully confirms that the communication with the upper-level ECU 10 via the communication buses 20a and 22a is normally performable. As described later, each of the first, second middle-level ECUs 12, 14 also periodically transmit the alive check communication frame to the upper-level ECU 10 via the communication bus 20a and the communication bus 22a.

In step S310, the upper-level ECU 10 attempts to receive the alive check communication frames from each of the first, second middle-level ECUs 12, 14. In step S320, the upper-level ECU 10 determines whether or not the receiving of the alive check communication frames from all of the middle-level ECUs 12, 14 in step S310 are successful. Upon determining that there is no middle-level ECU 12, 14 from which the receiving of the alive check communication frame is failed and the receiving of the alive check communication frames from all of the middle-level ECUs 12, 14 is successful, the upper-level ECU 10 proceeds to step S330. Upon determining that there is a middle-level ECU 12, 14 from which the receiving of the alive check communication frame is failed and the receiving of the alive check communication frame from not all of the middle-level ECUs 12, 14 is successful, the upper-level ECU 10 proceeds to step S340.

In step S330, the upper-level ECU 10 considers that the communication with the first middle-level ECU 12 and the communication with the second middle-level ECU 14 are normally performable and determines to keep use of the specified communication paths to transmit the communication frame including the control message. Accordingly, in transmitting the communication frame including the control message to the lower-level ECU 16, the upper-level ECU uses the first communication path and the second communication path shown in FIG. 2, for example.

In step S340, the upper-level ECU 10 considers that the abnormality has occurred in the communication path that including the middle-level ECU from which the receiving of the alive check communication frame is failed and the communication bus between the upper-level ECU10 and that middle-level ECU, and that the communication using that communication path is not normally performable. In this case, the upper-level ECU 10 determines to stop use of the communication path where the abnormality has occurred and determines to use another communication path in place of it.

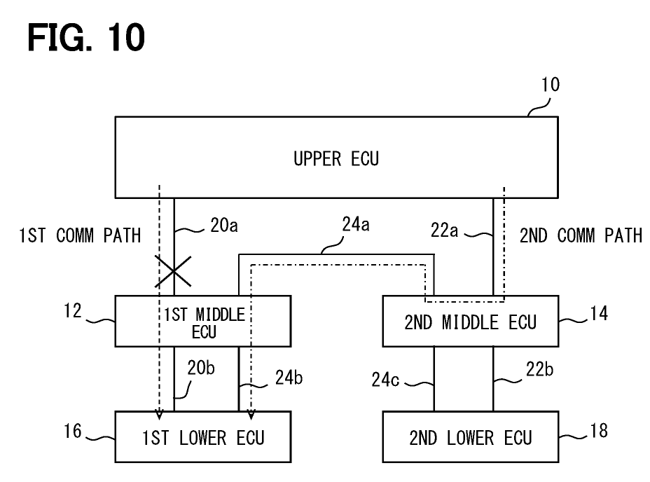

FIG. 10 shows, by way of example, a case in which the upper-level ECU 10 fails to receive the alive check communication frame from the first middle-level ECU 12. In this case, because of the failure to receive the alive check communication frame from the first middle-level ECU 12 via the communication bus 20a, the upper-level ECU 10 considers the communication path (first communication path) including the communication bus 20a and the first middle-level ECU 12 as being unusable. The upper-level ECU 10 determines to stop use of the communication path (first communication path) including the communication bus 20a and the first middle-level ECU 12. In this state, for example, if the communication frame including the control message to be transmitted toward the first lower-level ECU 16 via the communication path (first communication path) including the communication bus 20a and the first middle-level ECU 12 is generated, the upper-level ECU 10 transmits the communication frame via the second communication path including the second middle-level ECU 14.

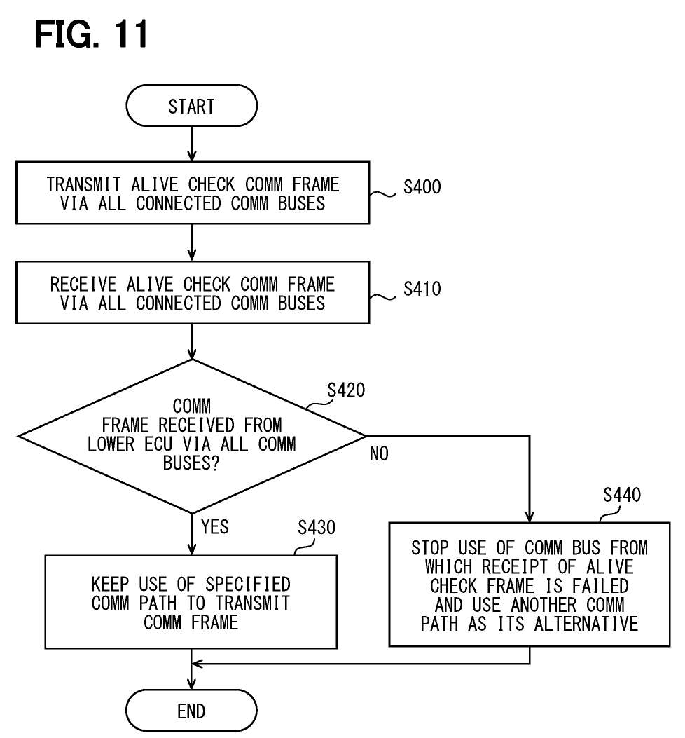

Next, the communication path abnormality detection function of the first, second middle-level ECU 12, 14 will be more specifically described. FIG. 11 is a flowchart showing the processes executed by the first, second middle-level ECUs 12, 14 for abnormality detection. The first, and second middle-level ECUs 12, 14 each execute the processes shown in the flowchart in FIG. 11 at given time intervals. The following describes an example in which the first middle-level ECU 12 executes the processes shown in the flowchart in FIG. 11.

In step S400, the first middle-level ECU 12 transmits the alive check communication frame via all of the connected communication buses 20a, 20b, 24a, 24b. Specifically, the first middle-level ECU 12 transmits the alive check communication frame via the communication bus 20a, the communication bus 24a, the communication bus 20b, and the communication bus 24b toward each of the upper-level ECU 10, the second middle-level ECU 14 and the subordinate which is the first lower-level ECU 16.

By receiving the alive check communication frame from the first middle-level ECU 12, the second middle-level ECU 14 can confirm that the communication with the first middle-level ECU 12 via the communication bus 24a is normally performable. The second middle-level ECU 14 also periodically transmits the alive check communication frame to the first middle-level ECU 12 via the communication bus 24a. Similarly, by receiving the alive check communication frame from the first middle-level ECU 12 via the communication bus 20b, 24b, the lower-level ECU 16 can confirm that the communication with the first middle-level ECU 12 via the communication bus 20b, 24b is normally performable. The first lower-level ECU 16 also periodically transmits the alive check communication frame to the first middle-level ECU 12 via the communication buses 20b, 24b.

In step S410, the first middle-level ECU 12 attempts to receive the alive check communication frame from each of the upper-level ECU 10, the second middle-level ECU 14, and the first lower-level ECU 16. In step S420, the first middle-level ECU 12 determines whether or not the receiving of the alive check communication frame from the first lower-level ECU 16 via all of the communication buses 20b and 24b is successful. Upon determining that the receiving of the alive check communication frame from the first lower-level ECU 16 via all of the communication buses 20b and 24b is successful, the first middle-level ECU 12 proceeds to step S430. Upon determining that among the communication buses 20b, 24b between the first middle-level ECU and the first lower-level ECU 16, there is a communication bus 20b, 24b from which the receiving of the alive check communication frame is failed and the receiving of the alive check communication frame from the first lower ECU 16 via not all of the communication buses 20b, 24b is successful, the first middle-level ECU 12 proceeds to step S440.

In step S430, the first middle-level ECU 12 considers that the communication with the first lower-level ECU 16 via each of the communication buses 20b and 24b is normally performable and determines to keep use of the specified communication paths to transmit the communication frames including the control messages. Accordingly, both of the communication bus 20b and the communication bus 24b are used for the first middle-level ECU 12 to transmits the communication frame including the control message to the first lower-level ECU 16.

In step S440, the first middle-level ECU 12 considers that an abnormality has occurred in the communication path including the communication bus from which the alive check communication frame is not receivable and the communication with the first lower-level ECU 16 via that communication bus is not normally performable. In this case, the first middle-level ECU 12 determines to stop use of the communication bus where the anomaly has occurred and determines to use another communication bus in place of it.

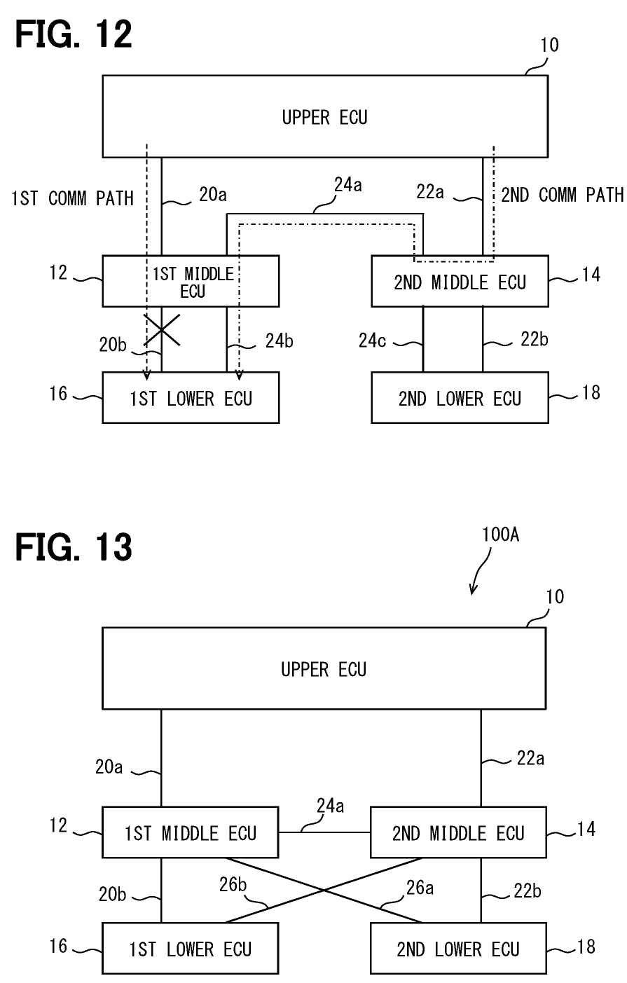

FIG. 12 shows, by way of example, a case in which the first middle-level ECU 12 fails to receive the alive check communication frame from the first lower-level ECU 16 via the communication bus 20b. In this case, because of the failure to receive the alive check communication frame from the first lower-level ECU 16 via the communication bus 20b, the first middle-level ECU 12 considers the communication bus 20b (first communication line) as being unusable. The first middle-level ECU 12 determines to stop use of the communication bus 20b. In this state, when the first middle-level ECU 12 receives the communication frame including the control message from the upper-level ECU 10 via the communication bus 20a, the first middle-level ECU 12 changes the relay destination of this communication frame into the communication bus 24b in place of the communication bus 20b. Specifically, the first middle-level ECU 12 uses the communication bus 24b in place of the communication bus 20b to transmit the communication frame including the control message. This makes it possible for the first lower-level ECU 16 to receive the communication frame including the control message via the communication bus 24b.

In the flowchart of FIG. 11, a respective first, second middle-level ECU 12, 14 makes a determination as to an occurrence of an abnormality of the communication bus 20b, 22b, 24b, 24c connected to its subordinate which is the first, second lower-level ECU 16, 18. In addition to this, the first, second middle-level ECU 12, 14 may make a determination as to an occurrence of an abnormality of the communication bus 24a connected to another middle-level ECU 12, 14. It may be preferable that the first, second middle-level ECU 12, 14 should notify the upper-level ECU 10 upon detecting the abnormality of the communication bus 24a. Accordingly, the upper-level ECU 10 can recognize that the second communication path including the communication bus 24a as part thereof is not usable to transmit the communication frame including the control message toward the first lower-level ECU 16. Therefore, the upper-level ECU 10 can determine to stop use of the second communication path and determine to use the first communication path in place of the second communication path.

The in-vehicle communication system 100 of the third embodiment is applicable to the in-vehicle communication system 100 of the first embodiment and the second embodiment, and additionally applicable to a communication system different from the in-vehicle communication system 100 of first embodiment and the second embodiment.

For example, when transmitting the communication frame including the control message toward the first lower-level ECU 16, the upper-level ECU 10 may transmit the communication frame including the control message by using the first communication path as long as it is detected that the communication using the first communication path is performable. Upon detection of the abnormality of the first communication path, the upper-level ECU 10 may transmit the communication frame including the control message by using the second communication path.

### Modifications

Preferred embodiments of the present disclosure have been described above. The present disclosure is not limited to the above-described embodiments and can be implemented by various modifications without departing from the spirit and scope of the present disclosure.

### Modification 1

In the in-vehicle communication system 100 of the first embodiment, the first communication path includes the communication bus 20a, the first middle-level ECU 12, and the communication bus 20b, the second communication path includes the communication bus 22a, the second middle-level ECU 14, the communication bus 24a, the first middle-level ECU 12 and the communication bus 24b, and the first and second communication paths are used as the communication path from the upper-level ECU 10 to the first lower-level ECU 16, for example.

However, the multiple communication paths from the upper-level ECU 10 to the first, second lower-level ECU 16, 18 are not limited to those described above. Depending on arrangement of the communication buses, the upper-level ECU 10 can transmit the communication frame to the first, second lower-level ECU 16, 18 via various communication paths.

For example, as shown in FIG. 13, a communication bus 26a between the first middle-level ECU 12 and the second lower-level ECU 18 and a communication bus 26b between the second middle-level ECU 14 and the first lower-level ECU 16 may be provided, instead of the communication buses 24b and 24c. In this case, the first communication path from the upper-level ECU 10 to the first lower-level ECU 16 can be the path from the upper-level ECU 10 to the first lower-level ECU 16 via the communication bus 20a, the first middle-level ECU 12, and the communication bus 20b. The second communication path can be the path to the first lower-level ECU 16 via the communication bus 22a, the second middle-level ECU 14, and the communication bus 26b.

Furthermore, in the configuration shown in FIG. 13, a third communication path may be provided between the upper-level ECU 10 and the first lower-level ECU 16. For example, the third communication path can be a path from the upper-level ECU 10 to the first lower-level ECU 16 via the communication bus 22a, the second middle-level ECU 14, the communication bus 24a, the first middle-level ECU 12 and the communication bus 20b.

### Modification 2

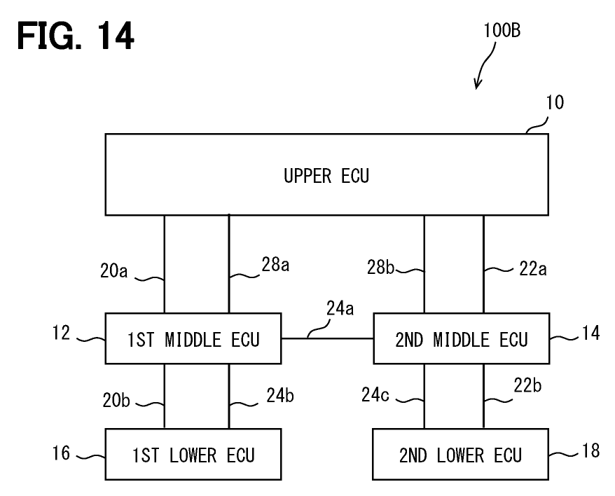

As another example of the communication bus arrangement, as shown in FIG. 14, a communication bus 28a between the upper-level ECU 10 and the first middle-level ECU 12, and a communication bus 28b between the upper-level ECU 10 and the second middle-level ECU 14 may be provided to the configuration of FIG. 1. In this case, it is possible to set up four or more communication paths between the upper-level ECU 10 and the first lower-level ECU 16, for example.

### Modification 3

In each of the embodiments and modifications described above, the upper-level ECU 10 is configured to transmit the communication frames including the control messages to all lower-level ECUs 16 and 18 via two or more communication paths. However, the upper-level ECU 10 may not necessarily transmit the communication frames including the control messages to all lower-level ECUs 16 and 18 via two or more communication paths. For example, it may be preferable that the upper-level ECU 10 transmit, via two or more communication paths, the communication frame including the control message to the lower-level ECU that executes the control process of relatively high importance. Via a single communication path only, the upper-level ECU 10 may transmit the communication frame including the control message to the lower-level ECU that executes the control process of relatively low importance.

In addition to or in place of the above, the upper-level ECU 10 can select whether to transmit via two or more communication paths or via only a single communication path based on the importance of the control message in the communication frame.

### Modification 4

In each of the embodiments and modifications described above, the in-vehicle communication systems 100, 100A, 100B are configured with three hierarchical levels (layers): the upper-level ECU 10; the first and second middle-level ECUs 12 and 14; and the first and second lower-level ECUs 16 and 18. However, the in-vehicle communication system of this disclosure may be configured with four or more hierarchical levels (layers).

### Modification 5

The systems and the methods thereof described in the present disclosure may be implemented by a special purpose computer configured by a processor programmed to provide one or more functions embodied by computer programs. The systems and methods described in the present disclosure may be implemented by a special purpose computer using a dedicated hardware logic circuit. The systems, and the method thereof described in the present disclosure may be implemented by one or more dedicated computers configured by a processor that executes a computer program in combination with one or more hardware logic circuits. For example, part or all of the functions provided by the upper-level ECU 10, the first, second middle-level ECUs 12, 14, and the first, second lower-level ECUs 16, 18 may be realized as hardware. A configuration in which a certain function is implemented by hardware logic circuitry includes a configuration in which the function is implemented using one or more ICs or the like. Part or all of the functions provided by the upper-level ECU 10, the first and second middle-level ECUs 12 and 14, and the first and second lower-level ECUs 16 and 18 may be implemented using any of a system-on-chip (SoC), an integrated circuit (IC), or a field-programmable gate array (FPGA). The concept of IC also includes ASIC (Application Specific Integrated Circuits). The computer program described above may be stored in a computer-readable non-transitory tangible storage medium as instructions to be executed by a computer. Examples of the storage medium for storing the computer program include a hard disk drive (i.e., HDD), a solid-state drive (i.e., SSD), and a flash memory. Furthermore, a program for causing a computer to function as the upper-level ECU 10, the first and second middle-level ECUs 12 and 14, and the first and second lower-level ECUs 16 and 18, as well as non-transitory tangible storage media such as semiconductor memory or the like on which such a program is stored, are also encompassed within the spirit and scope of the present embodiments.

### Disclosure of Technical Ideas

This specification discloses multiple technical ideas described in multiple items listed below. One or more items may be written in multiple-dependent form, referring to more than one preceding items in the alternative form. Further, one or more items may be written in multiple-multiple-dependent form, referring to multiple items that include an item written in the multiple-dependent form. The item written in the multiple-dependent form and the item written in the multiple-multiple dependent form each define multiple technical ideas. Furthermore, the multiple technical ideas in the multiple items listed below are also applicable to the control methods of the in-vehicle communication systems.

### TECHNICAL IDEA 1

An in-vehicle communication system (100) comprises:

a plurality of control devices (10, 12, 14, 16, 18), wherein

the plurality of control devices includes a upper-level control device (10) that transmits a communication frame including a control message, a middle-level control device (12, 14) that relays the communication frame transmitted by the upper-level control device, and a lower-level control device (16, 18) that receives the communication frame relayed by the middle-level control device and performs a control process based on the control message included in the received communication frame,

one or more communication lines (20a, 20b, 22a, 22b, 24a, 24b, 24c) are connected between the upper-level control device, the middle-level control device and the lower-level control device so that at least two or more communication paths are present each for the communication frame including the control message transmitted from the upper-level control device to reach the lower-level control device,

the upper-level control device repeatedly transmits the communication frame including the control message to the at least two or more communication paths over time, wherein each communication frame includes identification information used to identify an ordinal of the communication frame in a transmitting order,

the lower-level control device determines whether or not the ordinal of the received communication frame in the transmitting order is the same as or older than that of the previously received communication frame, based on the identification information of the received communication frame, and

the lower-level control device is configured such that:

upon determining that the ordinal of the received communication frame in the transmitting order is not the same as nor older than that of the previously received communication frame but is newer than that of the previously received communication frame, the lower-level control device executes the control process based on the control message included in the received communication frame; and

upon determining that the ordinal of the received communication frame in the transmitting order is the same as or older than that of the previously received communication frame, the lower-level control device does not execute the control process based on the control message included in the received communication frame.

### Technical Idea 2

In the in-vehicle communication system according to technical idea 1,

at a same time period, the upper-level control device transmits a plurality of the communication frames including the identification information indicating the same ordinal in the transmitting order toward the lower-level control device via the at least two or more communication paths.

### Technical Idea 3

In the in-vehicle communication system according to technical idea 1,

the upper-level control device transmits the repeatedly transmitted communication frame toward the lower-level control device via a single communication path that is switched over among the at least two or more communication paths in a given order per transmission of the communication frame.

### Technical Idea 4

In the in-vehicle communication system according to technical idea 2 or 3,

the upper-level control device transmits the communication frame at regular transmission time intervals.

### Technical Idea 5

In the in-vehicle communication system according to technical idea 3,

the upper-level control device changes a transmission interval of the repeatedly transmitted communication frame in the single communication path according to an estimated time for the communication frame to reach the lower-level control device.

### Technical Idea 6

In the in-vehicle communication system according to any one of technical ideas 1 to 5,

the middle-level control device includes at least a first middle-level control device (12) and a second middle-level control device (14), and

the at least two or more communication paths include a first communication path where the first middle-level control device relays the communication frame and a second communication path where the second middle-level control device relays the communication frame.

### Technical Idea 7

In the in-vehicle communication system according to technical idea 6,

in a case where the communication frame including the control message is transmitted to the lower-level control device (16) being a subordinate of the first middle-level control device:

the first communication path is from the upper-level control device to the lower-level control device via the first middle-level control device; and

the second communication path is from the upper-level control device to the lower-level control device via the second middle-level control device and then via the first middle-level control device.

### Technical Idea 8

In the in-vehicle communication system according to technical idea 7,

a first communication line (20b) for the first communication path and a second communication line (24b) for the second communication path are provided between the first middle-level control device and the lower-level control device being a subordinate of the first middle-level control device.

### Technical Idea 9

In the in-vehicle communication system according to any one of technical ideas 6 to 8,

the upper-level control device periodically receives an alive check communication frame from the first middle-level control device and the second middle-level control device, and

in a case where the upper-level control device fails to receive the alive check communication frame from one of the first middle-level control device and the second middle-level control device, the upper-level control device stops use of the communication path that includes the one of the first middle-level control device and the second middle-level control device and uses the communication path that includes the other of the first middle-level control device and the second middle-level control device to transmit the communication frame including the control message.

### Technical Idea 10

In the in-vehicle communication system according to technical idea 8,

the first middle-level control device periodically receives an alive check communication frame from the lower-level control device being a subordinate of the first middle-level control device via the first communication line and the second communication line, and

in a case where the first middle-level control device fails to receive the alive check communication frame from the lower-level control device via one of the first communication line and the second communication line, the first middle-level control device stops use of the one of the first communication line and the second communication line and uses the other of the first communication line and the second communication line to transmit the communication frame including the control message.

### Technical Idea 11

In the in-vehicle communication system according to any one of technical ideas 1 to 10,

the in-vehicle communication system is applied to at least one of a drive system, a steering system, and a braking system of a vehicle.

The following technical idea 12 is disclosed in the second embodiment described above.

### Technical Idea 12

An in-vehicle communication system (100) comprises a plurality of control devices (10, 12, 14, 16, 18), wherein

the plurality of control devices includes a upper-level control device (10) that transmits a communication frame including a control message, a middle-level control device (12, 14) that relays the communication frame transmitted by the upper-level control device, and a lower-level control device (16, 18) that receives the communication frame relayed by the middle-level control device and performs a control process based on the control message included in the received communication frame,

one or more communication lines (20a, 20b, 22a, 22b, 24a, 24b, 24c) are connected between the upper-level control device, the middle-level control device and the lower-level control device so that at least two or more communication paths are present each for the communication frame including the control message transmitted from the upper-level control device to reach the lower-level control device,

the upper-level control device repeatedly transmits the communication frame including the control message over time,

the upper-level control device transmits the repeatedly transmitted communication frame toward the lower-level control device via a single communication path that is switched over among the at least two or more communication paths in a given order per transmission of the communication frame.

The following technical ideas 13 and 14 are disclosed in the third embodiment described above.

### Technical Idea 13

An in-vehicle communication system (100) comprises a plurality of control devices (10, 12, 14, 16, 18), wherein

the plurality of control devices includes a upper-level control device (10) that transmits a communication frame including a control message, a middle-level control device (12, 14) that relays the communication frame transmitted by the upper-level control device, and a lower-level control device (16, 18) that receives the communication frame relayed by the middle-level control device and performs a control process based on the control message included in the received communication frame,

one or more communication lines (20a, 20b, 22a, 22b, 24a, 24b, 24c) are connected between the upper-level control device, the middle-level control device and the lower-level control device so that at least two or more communication paths are present each for the communication frame including the control message transmitted from the upper-level control device to reach the lower-level control device,

the upper-level control device repeatedly transmits the communication frame including the control message over time,

the middle-level control device includes at least a first middle-level control device (12) and a second middle-level control device (14),

the upper-level control device periodically receives an alive check communication frame from the first middle-level control device and the second middle-level control device, and

in a case where the upper-level control device fails to receive the alive check communication frame from one of the first middle-level control device and the second middle-level control device, the upper-level control device stops use of the communication path that includes the one of the first middle-level control device and the second middle-level control device, and uses the communication path that includes the other of the first middle-level control device and the second middle-level control device to transmit the communication frame including the control message.

### Technical Idea 14

An in-vehicle communication system (100) comprises a plurality of control devices (10, 12, 14, 16, 18), wherein

the plurality of control devices includes a upper-level control device (10) that transmits a communication frame including a control message, a middle-level control device (12, 14) that relays the communication frame transmitted by the upper-level control device, and a lower-level control device (16, 18) that receives the communication frame relayed by the middle-level control device and performs a control process based on the control message included in the received communication frame,

one or more communication lines (20a, 20b, 22a, 22b, 24a, 24b, 24c) are connected between the upper-level control device, the middle-level control device and the lower-level control device so that at least two or more communication paths are present for the communication frame including the control message transmitted from the upper-level control device to reach the lower-level control device,

the communication lines include a first communication line (20b) and a second communication line (24b) each provided between the middle-level ECU and the lower-level ECU,

the upper-level control device repeatedly transmits the communication frame including the control message over time,

the middle-level control device periodically receives an alive check communication frame from the lower-level ECU being is a subordinate of the middle-level control device via the first communication line and the second communication line, and

in a case where the middle-level fails to receive the alive check communication frame from the lower-level control device via one of the first communication line and the second communication line, the middle-level control device stops use of the one of the first communication line and the second communication line and uses the other of the first communication line and the second communication line to transmit the communication frame including the control message.

What is claimed is:

1. An in-vehicle communication system comprising:
a plurality of control devices each provided by at least a processor and memory, wherein
the plurality of control devices includes a upper-level control device that transmits a communication frame including a control message, a middle-level control device that relays the communication frame transmitted by the upper-level control device, and a lower-level control device that receives the communication frame relayed by the middle-level control device and performs a control process based on the control message included in the received communication frame,
one or more communication lines are connected between the upper-level control device, the middle-level control device and the lower-level control device so that at least two or more communication paths are present each for the communication frame including the control message transmitted from the upper-level control device to reach the lower-level control device,
the upper-level control device repeatedly transmits the communication frame including the control message to the at least two or more communication paths over time, wherein each communication frame includes identification information used to identify an ordinal of the communication frame in a transmitting order,
the lower-level control device determines whether or not the ordinal of the received communication frame in the transmitting order is the same as or older than that of the previously received communication frame, based on the identification information of the received communication frame, and
the lower-level control device is configured such that:
upon determining that the ordinal of the received communication frame in the transmitting order is not the same as nor older than that of the previously received communication frame but is newer than that of the previously received communication frame, the lower-level control device executes the control process based on the control message included in the received communication frame; and
upon determining that the ordinal of the received communication frame in the transmitting order is the same as or older than that of the previously received communication frame, the lower-level control device does not execute the control process based on the control message included in the received communication frame.

2. The in-vehicle communication system according to claim 1, wherein
at a same time period, the upper-level control device transmits a plurality of the communication frames including the identification information indicating the same ordinal in the transmitting order toward the lower-level control device via the at least two or more communication paths.

3. The in-vehicle communication system according to claim 1, wherein
the upper-level control device transmits the repeatedly transmitted communication frame toward the lower-level control device via a single communication path that is switched over among the at least two or more communication paths in a given order per transmission of the communication frame.

4. The in-vehicle communication system according to claim 2, wherein
the upper-level control device transmits the communication frame at regular transmission time intervals.

5. The in-vehicle communication system according to claim 3, wherein
the upper-level control device changes a transmission interval of the repeatedly transmitted communication frame in the single communication path according to an estimated time for the communication frame to reach the lower-level control device.

6. The in-vehicle communication system according to claim 1, wherein
the middle-level control device includes at least a first middle-level control device and a second middle-level control device, and
the at least two or more communication paths include a first communication path where the first middle-level control device relays the communication frame and a second communication path where the second middle-level control device relays the communication frame.

7. The in-vehicle communication system according to claim 6, wherein
in a case where the communication frame including the control message is transmitted to the lower-level control device being a subordinate of the first middle-level control device:
the first communication path is from the upper-level control device to the lower-level control device via the first middle-level control device; and
the second communication path is from the upper-level control device to the lower-level control device via the second middle-level control device and then via the first middle-level control device.

8. The in-vehicle communication system according to claim 7, wherein
a first communication line for the first communication path and a second communication line for the second communication path are provided between the first middle-level control device and the lower-level control device being a subordinate of the first middle-level control device.

9. The in-vehicle communication system according to claim 6, wherein
the upper-level control device periodically receives an alive check communication frame from the first middle-level control device and the second middle-level control device, and
in a case where the upper-level control device fails to receive the alive check communication frame from one of the first middle-level control device and the second middle-level control device, the upper-level control device stops use of the communication path that includes the one of the first middle-level control device and the second middle-level control device and uses the communication path that includes the other of the first middle-level control device and the second middle-level control device to transmit the communication frame including the control message.

10. The in-vehicle communication system according to claim 8, wherein
the first middle-level control device periodically receives an alive check communication frame from the lower-level control device being a subordinate of the first middle-level control device via the first communication line and the second communication line, and
in a case where the first middle-level control device fails to receive the alive check communication frame from the lower-level control device via one of the first communication line and the second communication line, the first middle-level control device stops use of the one of the first communication line and the second communication line and uses the other of the first communication line and the second communication line to transmit the communication frame including the control message.

11. The in-vehicle communication system according to claim 1, wherein
the in-vehicle communication system is applied to at least one of a drive system, a steering system, and a braking system of a vehicle.

12. A control method of an in-vehicle communication system including a plurality of control devices, wherein
the plurality of control devices includes a upper-level control device that transmits a communication frame including a control message, a middle-level control device that relays the communication frame transmitted by the upper-level control device, and a lower-level control device that receives the communication frame relayed by the middle-level control device and performs a control process based on the control message included in the received communication frame, and
one or more communication lines are connected between the upper-level control device, the middle-level control device and the lower-level control device so that at least two or more communication paths are present for the communication frame including the control message transmitted from the upper-level control device to reach the lower-level control device,
the control method comprising:
the upper-level control device repeatedly transmitting the communication frame including the control message to the at least two or more communication paths over time, wherein each communication frame includes identification information used to identify an ordinal of the communication frame in a transmitting order;
the lower-level control device determining based on the identification information of the received communication frame whether or not the ordinal of the received communication frame in the transmitting order is the same as or older than that of the previously received communication frame; and
the lower-level control device performing processes such that:
upon determining that the ordinal of the received communication frame in the transmitting order is not the same as nor older than that of the previously received communication frame but is newer than that of the previously received communication frame, the lower-level control device executes the control process based on the control message included in the received communication frame; and
upon determining that the ordinal of the received communication frame in the transmitting order is the same as or older than that of the previously received communication frame, the lower-level control device does not execute the control process based on the control message included in the received communication frame.
